(19) United States
(12) Patent Application Publication
(10) Pub. No.: US 2011/0148902 A1
(43) Pub. Date: Jun. 23, 2011

(54) Evaluation method of display device

(75) Inventors: Shuichi Haga, Kanagawa (JP); Takehiro Nakatsue, Kanagawa (JP); Junichi Ohsako, Tokyo (JP); Tatsuhiko Matsumoto, Tokyo (JP)

(73) Assignee: Sony Corporation, Tokyo (JP)

(21) Appl. No.: 12/926,344

(22) Filed: Nov. 12, 2010

(30) Foreign Application Priority Data
Dec. 22, 2009 (JP) 2009-291251

(51) Int. Cl. G09G 5/02

(52) U.S. Cl. 345/589

(57) ABSTRACT

An evaluation method of a display device includes steps of obtaining a measured value of color difference, for the display device to be evaluated which is in a state of displaying a predetermined color reference image, determining a detection limit value of color difference for the display device, in consideration of spectral luminous efficiency which has a dependence on color, with use of a subjective evaluation result of color difference obtained for the display device which is in a state of displaying both the color reference image and a color comparison image in parallel, determining an evaluation parameter with use of the measured value of color difference and the detection limit value of color difference; and evaluating a display property of the display device with use of the evaluation parameter.

### BACKGROUND OF THE INVENTION

1. Field of the Invention

The present invention relates to a method of evaluating a color reproduction property and the like in a display device displaying a color image and the like.

2. Description of the Related Art

Previously, various evaluation methods have been proposed for evaluating a display property of a display device using a Cathode Ray Tube (CRT), a Liquid Crystal Display (LCD), a Plasma Display Panel (PDP), an organic Electro Luminescence (EL) or the like.

For example, Japanese Unexamined Patent Application Publications No. 2009-157219 and No. 2009-159580 each propose a technique of evaluating a color reproduction property of a display device, by using a color difference as an index value at the time of an evaluation.

### SUMMARY OF THE INVENTION

Here, a color reproduction property is one of important display properties in a display device, but is merely defined by using a range (for example, sRGB space) of the color reproduction property at present. In other words, so far, there has been no index (criterion) that numerically indicates to what extent a color can be faithfully presented on a display device with respect to an actual color. For this reason, previously, as to the color reproduction property of a display device, companies have individually carried out image-quality designs in their own ways.

Further, with regard to the color difference used as the index value in the technique in each of Japanese Unexamined Patent Application Publications No. 2009-157219 and No. 2009-159580 as well, the value itself is a physical parameter obtained based on a measurement result. Therefore, considering that spectral luminous efficiency of a human being changes depending on the color, it is difficult to perform an appropriate evaluation.

Thus, in the evaluation techniques in the past, it is difficult to appropriately evaluate the display property such as the color reproduction property and thus, a proposal of an improved technique has been desired.

In view of the foregoing, it is desirable to provide an evaluation method of a display device, which is capable of appropriately evaluating a display property in the display device.

According to an embodiment of the present invention, there is provided an evaluation method of a display device, the method including steps of: obtaining a measured value of color difference, for the display device to be evaluated which is in a state of displaying a predetermined color reference image; determining a detection limit value of color difference for the display device, in consideration of spectral luminous efficiency which has a dependence on color, with use of a subjective evaluation result of color difference obtained for the display device which is in a state of displaying both the color reference image and a color comparison image in parallel; determining an evaluation parameter with use of the measured value of color difference and the detection limit value of color difference; and evaluating a display property of the display device with use of the evaluation parameter.

In the evaluation method of the display device according to the embodiment, the measured value of the color difference for the display device to be evaluated is obtained, and by using the subjective evaluation result of the color difference for the display device, the detection limit value of the color difference for the display device, in consideration of the spectral luminous efficiency which has a dependence on color, is determined. Further, the evaluation parameter is determined by using the measured value of the color difference and the detection limit value of the color difference, and the display property of the display device is evaluated with use of the evaluation parameter. In other words, the display property is evaluated with use of, as an index, the evaluation parameter obtained by using the detection limit value of the color difference in consideration of the spectral luminous efficiency which has a dependence on color. As a result, as compared to the techniques in the past in which an evaluation is performed without considering such spectral luminous efficiency which has a dependence on color, an objective display-property evaluation further matching the sense of a human is realized.

According to the evaluation method of the display device of the embodiment, the measured value of the color difference for the display device to be evaluated is obtained; and by using the subjective evaluation result of the color difference for the display device, the detection limit value of the color difference in consideration of the spectral luminous efficiency which has a dependence on color is determined; the evaluation parameter is determined by using the measured value of the color difference and the detection limit value of the color difference; and the display property of the display device is evaluated with use of the evaluation parameter. Therefore, it may be possible to realize an objective display-property evaluation further matching the sense of a human, as compared to the techniques in the past. Accordingly, the display property in the display device can be appropriately evaluated.

Other and further objects, features and advantages of the invention will appear more fully from the following description.

### BRIEF DESCRIPTION OF THE DRAWINGS

FIG. 1 is a flowchart illustrating an evaluation method of a display device according to an embodiment of the present invention;

FIG. 2A and FIG. 2B are schematic diagrams for explaining a method of measuring a color difference in the display device;

FIG. 3A and FIG. 3B are diagrams illustrating an example of a measurement result of the color difference in the display device;

FIG. 4 is a schematic diagram illustrating an example of an image used in a subjective evaluation experiment;

FIG. 5 is a characteristic diagram for explaining the relationship between a subjective evaluation experiment result and a detection-limit color difference.

FIG. 6 is a diagram illustrating an example of the relationship between the subjective evaluation experiment result and the detection-limit color difference;

FIG. 7 is a diagram illustrating an example of the detection-limit color difference obtained from the subjective evaluation experiment result;

FIG. 8A and FIG. 8B are diagrams illustrating an example of a high color-reproduction evaluation parameter obtained in each display device;

FIG. 9A through FIG. 9D are diagrams illustrating the high color-reproduction evaluation parameter illustrated in FIG. 8A and FIG. 8B per color;

FIG. 10 is a schematic diagram for explaining a viewing angle in an evaluation method of a display device according to a modification 1 of the present invention;

FIG. 11 is a characteristic diagram for explaining the relationship between the viewing angle and the high color-reproduction evaluation parameter;

FIG. 12 is a characteristic diagram illustrating an example of the relationship between the viewing angle and the high color-reproduction evaluation parameter;

FIG. 13 is a characteristic diagram illustrating another example of the relationship between the viewing angle and the high color-reproduction evaluation parameter;

FIG. 14 is a characteristic diagram illustrating an example of the relationship between the viewing angle and the high color-reproduction evaluation parameter per color;

FIG. 15 is a characteristic diagram illustrating an example of the relationship between illuminance of an external environment and the high color-reproduction evaluation parameter in an evaluation method of a display device according to a modification 2 of the present invention; and

FIG. 16 is a block diagram illustrating a display device according to an application example of the present invention.

### DETAILED DESCRIPTION OF THE PREFERRED EMBODIMENT

An embodiment of the present invention will be described below in detail with reference to the drawings. Incidentally, the description will be provided in the following order.

1. Embodiment (method of evaluating color reproduction property of display device by using high color-reproduction evaluation parameter)

### 2. Modification

Modification 1 (method of evaluating viewing angle property of display device with use of high color-reproduction evaluation parameter)

Modification 2 (method of evaluating luminous environment property of display device with use of high color-reproduction evaluation parameter)

3. Application example (display device using high color-reproduction evaluation parameter as index)

### 1. Embodiment

### Steps of Evaluation Method of Display Device

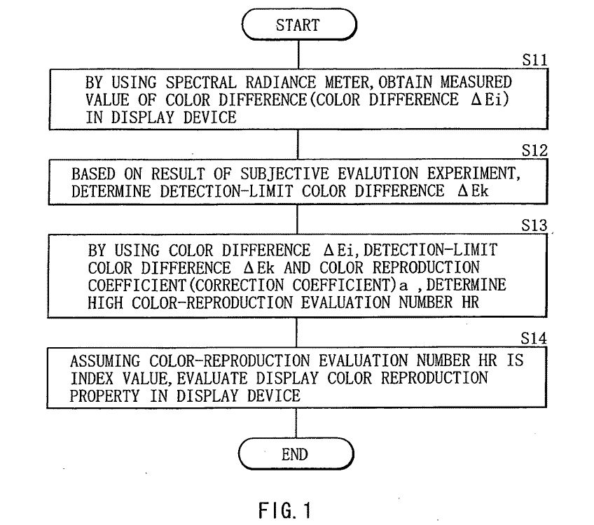

FIG. 1 is a flowchart illustrating main processing steps in an evaluation method of a display device according to an embodiment of the present invention. The evaluation method of the display device in the present embodiment is a method for evaluating a display property in the display device that displays a color image and the like, and here, the method is for evaluating a color reproduction property in the display device.

(Acquisition of Measured Value of Color Difference: S11)

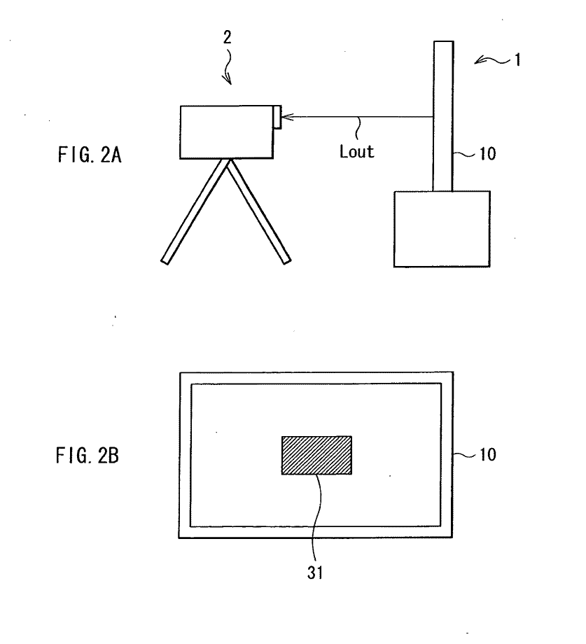

In this evaluation method, first, as illustrated in, for example, FIG. 2A, a measured value of a color difference (color difference ΔEi) in a display device 1 that is an evaluating object is acquired by using, for example, a spectral radiance meter 2 (step S11 in FIG. 1). Specifically, display light Lout from the display device 1, which displays a predetermined color reference image (color-chart image) 31 to be described later on a display section 10 as illustrated in, for example, FIG. 2B, is subjected to colorimetry with the spectral radiance meter 2, and therefore the color difference ΔEi that is the measured value is obtained. At the time, the color reference image 31 having, for example, an aspect ratio (size in vertical direction (V)/size in horizontal direction (H)) of about 1/5 can be used, and as a background color, for example, a gray on the order of 20% can be used. Further, the measurement is desirably performed in, for example, the inside of a darkroom.

Here, as the display device 1 to be evaluated, displays of various systems such as the CRT, LCD, PDP and organic EL display can be applied. Further, as application examples of such a display, there are various types of device such as a monitor for a television (TV) and a monitor for a Personal Computer (PC).

Furthermore, as the color difference, as expressed by, for example, the following equations (1) through (4), it is desirable to use a color difference based on CIELAB assuming a uniform color space. Specifically, first, based on a (Xi, Yi, Zi) signal formed by tristimulus values X, Y, and Z obtained by the spectral radiance meter 2, values (L*, a*, b*) are calculated in an image processing section formed by a not-illustrated PC and the like, by using the following equations (2) through (4). These values are in the CIE 1976 L*a*b* color space (CIELAB color space) recommended by the Commission Internationale de l'Éclairage (CIE) in 1976. This CIELAB color space is recommended as a uniform color space and is a space in consideration of uniformity with respect to human's visual perception of colors. Incidentally, Xn, Yn and Zn in these equations (2) through (4) are tristimulus values of a perfect reflecting diffuser that targets D65. Subsequently, by using these values (L*, a*, b*), the image processing section calculates a color difference ΔE*ab corresponding to the color difference ΔEi based on the following equation (1).

$$\begin{matrix}\begin{matrix}Δ {E}^{*} a b = \sqrt{{( Δ {L}^{*} )}^{2} + {( Δ {a}^{*} )}^{2} + {( Δ {b}^{*} )}^{2}} & ( 1 )\end{matrix} \\ \{ \begin{matrix}{L}^{*} = 116 {( Y / Yn )}^{1 / 3} - 16 & ( 2 ) \\ {a}^{*} = 500 [ {( X / Xn )}^{1 / 3} - {( Y / Yn )}^{1 / 3} ] & ( 3 ) \\ {b}^{*} = 200 [ {( Y / Yn )}^{1 / 3} - {( Z / Zn )}^{1 / 3} ] & ( 4 )\end{matrix}\end{matrix}$$

(where, Xn, Yn and Zn are tristimulus values of a light source (standard value), and X, Y and Z are actual measured values)

Here, the color difference ΔEi obtained in this way is affected by an image-quality property of the display device 1 and thus is a value that varies depending on a displayed reference color. Therefore, when the display device 1 is a TV device, as image quality of the television at the time, it is desirable to use an image-quality mode with no image creation (e.g. a custom mode or a cinema mode) if possible.

Further, as the above-mentioned color reference image (color-chart image), for example, a Macbeth chart that is a standard color chart can be used. Incidentally, in the following example, among reference colors in this Macbeth chart, there are used eight colors in total, which are: three primary colors of R (red, #15), G (green, #14) and B (blue, #13); three memory colors of light skin (#2), blue sky (#3) and foliage (#4); and gray scales of 128 levels (#22) and 64 levels (#23).

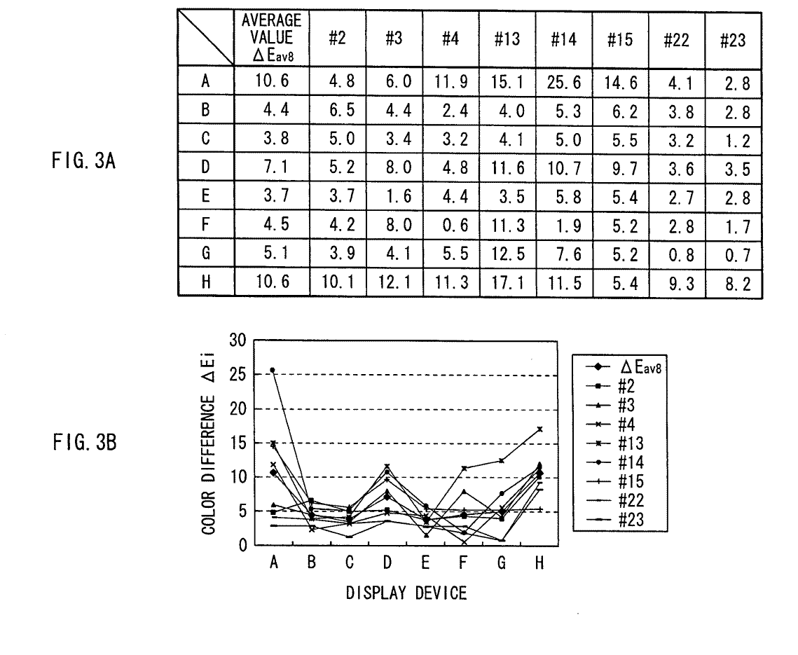

In this way, color differences ΔEi as illustrated in, for example, FIG. 3A and FIG. 3B are obtained. Specifically, FIG. 3A illustrates, in a table, the color difference .Ei per reference color (the above-mentioned eight colors of #2 to #4, #13 to #15 and #22 to #23) and an average value (average color difference) ΔEav8 of these color differences Ei of the eight colors, in each of display devices A through H each serving as an example (TV device) of the display device 1. Further, FIG. 3B illustrates, in a graph, the value of each of the color differences .Ei illustrated in FIG. 3A. From these FIG. 3A and FIG. 3B, it is found that although the above-mentioned image-quality mode without image creation is used here, the values of the color differences ΔEi in each of the display devices A through H are large. Further, here, a range of the obtained color differences ΔEi is between 0.7 and 25.6 both inclusive. Furthermore, when a comparison is made by using the average color difference ΔEav8 of the eight colors, it is found that the display device E has the smallest value (ΔEav8=3.7), and the display devices A and H have the largest value (ΔEav8=10.6).

(Acquisition of Detection-Limit Color Difference (Color-Difference Limit Value): S12)

Next, based on a result of a predetermined subjective evaluation experiment (subjective evaluation result) that will be described below, the image processing section determines a detection-limit color difference ΔEk that is a detection limit value of the color difference in the display device 1 (step S12). This detection-limit color difference ΔEk corresponds to a minimum color difference value among values in a range where difference can be perceived, and is a color difference value in consideration of spectral luminous efficiency of a human with respect to a color change, as will be described later.

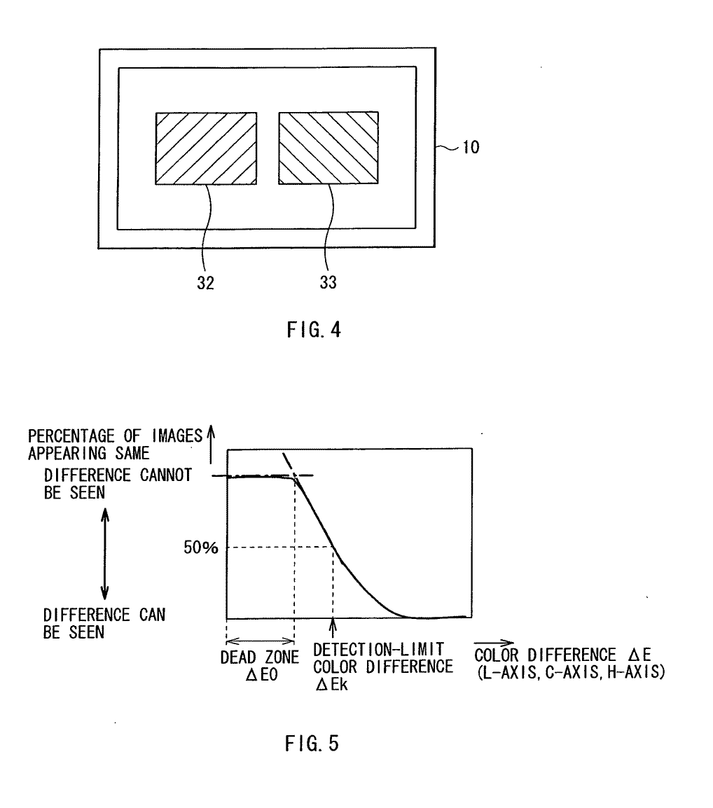

Here, the above-mentioned subjective evaluation experiment will be performed as follows. Specifically, first, as illustrated in, for example, FIG. 4, the above-described color reference image (color-chart image) 32 and the color comparison image (color conversion image) 33 are displayed in parallel. The color comparison image 33 can be created in such a way that by using, for example, the above-described eight reference colors, luminance (L-axis), chroma (C-axis) and hue (H-axis) are changed by shifting the color difference ΔE at a predetermined interval in a positive (plus) direction and a negative (minus) direction. Incidentally, as for the gray (#22 and #23), no change occurs in the hue and thus, only the L-axis and the C-axis are changed.

Subsequently, plural color comparison images 33 thus obtained are sequentially displayed on the display section 10, and an experimenter determines, whenever necessary, whether the color difference ΔE between the color reference image 32 and the color comparison image 33 can be perceived. Specifically, when determining that the color reference image 32 and the color comparison image 33 appear in the same color (the color difference ΔE cannot be perceived), the experimenter pushes a “Yes” button of a control switch at hand. On the other hand, when determining that the color reference image 32 and the color comparison image 33 have different color from each other (the color difference ΔE can be perceived), the experimenter pushes a “No” button of the control switch. Incidentally, such control of sequentially displaying the plural color comparison images 33 and compilation of the answer results obtained from the experimenter are performed by using, for example, a PC not illustrated.

As such a subjective evaluation experiment, a method of limits, a constant method, a double up-and-down method or the like can be used. Among them, the double up-and-down method is used here in consideration of variations in accuracy. This double up-and-down method is a method of performing display, at the time of sequentially displaying the color comparison images 33, by changing the color difference ΔE sequentially in a direction from larger to smaller in the order of sign + to sign −. An image opposite to a reference point on the axis is displayed and thus, the order cannot be predicted. Therefore, this is used as one of subjective evaluation experiments by which highly reliable results can be obtained.

By the subjective evaluation experiment as described above, a result (subjective evaluation result) illustrated in, for example, FIG. 5 is obtained. In FIG. 5, a horizontal axis indicates the color difference ΔE (color difference along the L-axis, C-axis, and H-axis) in the color comparison image 33. Further, a vertical axis indicates the percentage of determining that the color reference image 32 and the color comparison image 33 appear in the same color by the experimenter (the color difference ΔE cannot be perceived). A case in which the difference cannot be seen at all is 100%, while a case in which the difference can be completely seen is 0%. Here, as illustrated in FIG. 5, the value of the color difference ΔE at the time when the percentage in which the images appear in the same color is 50% is defined as a detection-limit color difference ΔEk. Incidentally, a dead zone ΔE0 illustrated in FIG. 5 represents a range of the color differences ΔE when this percentage in which the images appear in the same color is 100%.

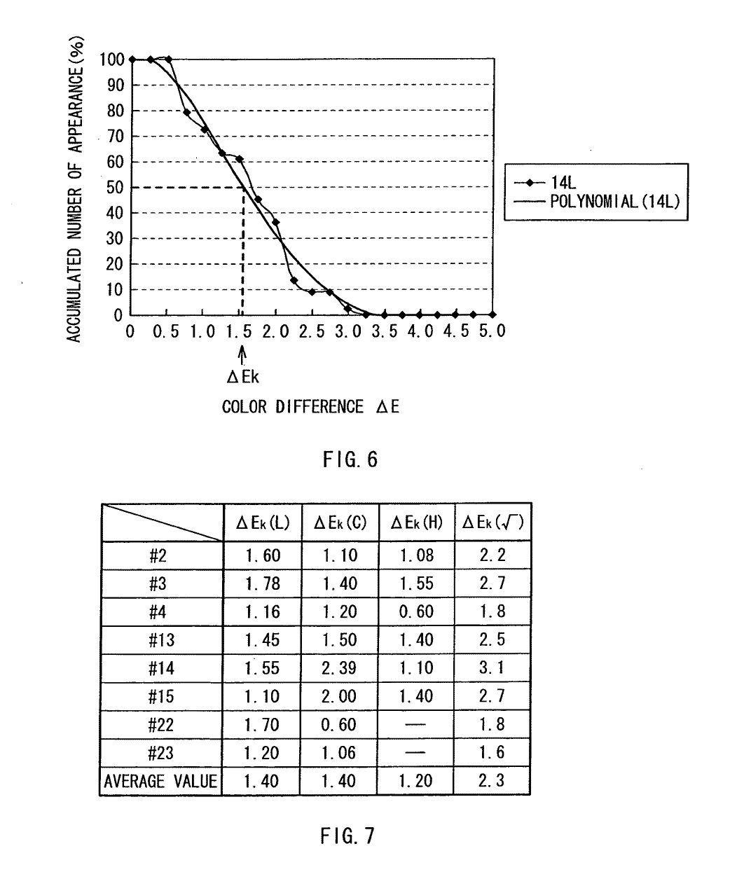

Here, FIG. 6 illustrates an example (a case in which the color difference ΔE is changed on the L-axis for the green (#14)) of the subjective evaluation result thus obtained. Incidentally, a “polynomial (14L)” illustrated in FIG. 6 represents a curve (sigmoid curve) formed by approximating the obtained results with a polynomial (sixth-degree equation). In this example, it is found that the value of the color difference ΔE at the time when the above-mentioned percentage in which the images appear in the same color (the accumulated number of appearances indicated by the vertical axis in FIG. 6) is 50%, namely, the detection-limit color difference ΔEk, is 1.5.

Further, FIG. 7 illustrates, in a table, the detection-limit color differences .Ek(L), .Ek(C) and .Ek(H) along the L-axis, C-axis and H-axis, respectively, per reference color (the eight colors of #2 to #4, #13 to #15 and #22 to #23) described above, and an average value of these detection-limit color differences of the eight colors. Here, various techniques may be named as the way of determining the average value, and for example, an arithmetic mean, a geometrical mean, and a harmonic mean can be used. However, in the present embodiment, the uniform color space is assumed as an example and thus, the shape of the detection-limit color difference is predicted to be oval, and it is conceivable that its radius will be a Euqlidean distance. Thus, here, as the average value of the detection-limit color differences, as expressed by the following equation (5), there is used a value (detection-limit color difference .Ek(√)) obtained by an average value of the respective root sum squares for the detection-limit color differences .Ek(L), .Ek(C) and .Ek(H). From this FIG. 7, it is found that the values of the respective detection-limit color differences .Ek vary from color to color and from axis to axis. Incidentally, in the following description, it is assumed that as the detection-limit color difference .Ek, the above-mentioned detection-limit color difference .Ek(√) is used. However, the way of determining the average value is not limited to this assumption, depending on the color space in use.

ΔE(√)=\sqrt{{ΔE(L)}²+{ΔE(C)}²+{ΔE(H)}²} (5)

(Calculation of High Color-Reproduction Evaluation Parameter HR: S13)

Next, by using the color difference .Ei serving as the measured value obtained in step S11 and the detection-limit color difference .Ek obtained in step S12, the image processing section determines an evaluation parameter (high color-reproduction evaluation parameter HR) (step S13).

This high color-reproduction evaluation parameter HR is an evaluation parameter in consideration of sensitivity of a human to a change in color, and defines, as a criterion, how many times the color difference .Ei serving as the measured value is larger than the detection-limit color difference .Ek. Specifically, the high color-reproduction evaluation parameter HR is defined by the following equation (6). In other words, the high color-reproduction evaluation parameter HR is determined through subtracting, from a predefined maximum value (score of 100) of this high color-reproduction evaluation parameter HR, a value obtained by multiplying a color difference ratio that is a ratio between the color difference .Ei and the detection-limit color difference .Ek (color difference .Ei/detection-limit color difference .Ek) by a color reproduction coefficient a that is a predetermined correction coefficient (adjustment coefficient). Here, the color reproduction coefficient a is the correction coefficient for adjusting the value of the high color-reproduction evaluation parameter HR, and is determined so that, for example, the average value (average score) of the high color-reproduction evaluation parameters HR becomes a score of 80. The value (score) of the high color-reproduction evaluation parameter HR thus determined decreases, relative to a score of 100 serving as a maximum value (perfect score), as the value of the color difference .Ei increases (also, as the value of the detection-limit color difference .Ek decreases).

$$\begin{matrix}HRi = 100 - a \times \frac{Δ Ei}{Δ Ek} \\ = 100 - \\ a \times \frac{{( ideal color reproduction - actual color reproduction )}^{2}}{Δ Ek}\end{matrix} \qquad ( 6 )$$

HR: High color-reproduction evaluation parameter

.Ei: Color difference

i: Index (color of color chart in use)

.Ek: Detection-limit color difference

a: Color reproduction coefficient (correction coefficient)

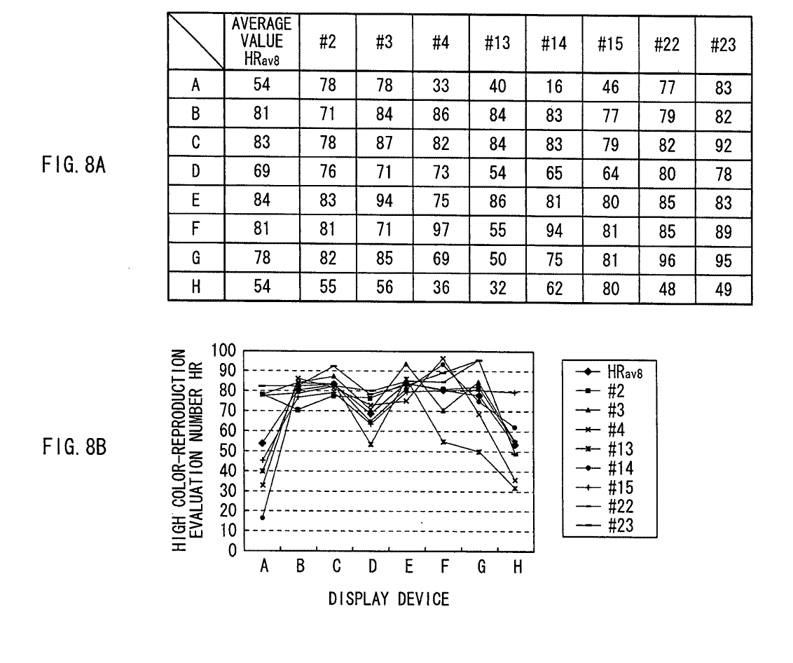

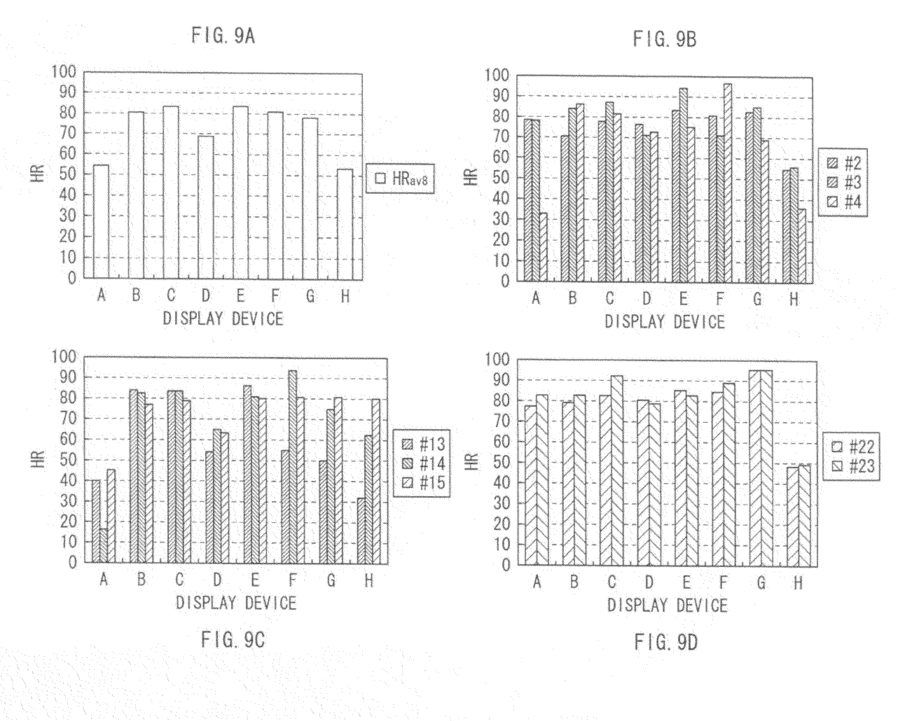

As a result, there are obtained the high color-reproduction evaluation parameters HR as illustrated in FIG. 8A and FIG. 8B as well as FIG. 9A through FIG. 9D. Specifically, FIG. 8A illustrates, in a table, the high color-reproduction evaluation parameter HR per reference color (the eight colors of #2 to #4, #13 to #15 and #22 to #23) and an average value HRav8 of these high color-reproduction evaluation parameters HR of the eight colors in each of the above-mentioned display devices A through H. Further, FIG. 8B illustrates, in a graph, each of the high color-reproduction evaluation parameters HR illustrated in FIG. 8A, and FIG. 9A through FIG. 9D each represent, in a graph, details of the graph illustrated in FIG. 8A for each of the display devices A through H and for each color. Incidentally, here, the high color-reproduction evaluation parameter HR is determined with the assumption that the above-described color reproduction coefficient a is 10. From these FIG. 8A through FIG. 9D, it is found that each of the values of the high color-reproduction evaluation parameters HR varies according to each of the display devices A through H and each color.

(Evaluation of Display Property: S14)

Next, assuming that the high color-reproduction evaluation parameter HR thus obtained is an index value, a display property (here, color reproduction property) of the display device 1 is evaluated in, for example, the image processing section (step S14). Specifically, here, assuming that the magnitude of the high color-reproduction evaluation parameter HR is an index, the color reproduction property in the display device 1 is evaluated. In other words, the evaluation can result in such a consequence that the larger the value of this high color-reproduction evaluation parameter HR is (the closer to 100 the score is), the better the color reproduction property in the display device 1 is. On the other hand, on the contrary, the evaluation can result in such a consequence that the smaller the value of this high color-reproduction evaluation parameter HR is (the closer to 0 the score is), the worse the color reproduction property in the display device 1 is.

For example, in the example illustrated in FIG. 8A through FIG. 9D, it is found that there are display devices showing that the average value HRav8 of the eight colors is a high score of closer to 80, while there are display devices showing that the average value is a low score on the order of 50. Further, in, for example, the display device C, as for each of the three primary colors (red (#15), green (#14) and blue (#13)), the three memory colors (light skin (#2), blue sky (#3) and foliage (#4)), and the two grays (#22 and #23), the high color-reproduction evaluation parameter HR shows a high value on average and thus can be said that the display device C is a display device in which the color reproduction property is particularly excellent.

In this way, in the present embodiment, the color difference .Ei serving as the measured value is obtained for the display device 1 to be evaluated. Further, by using the subjective evaluation result of the color difference for the display device 1, there is determined the detection limit value of the color difference (detection-limit color difference .Ek) for the display device 1, in consideration of the spectral luminous efficiency which has a dependence on color. Furthermore, the evaluation parameter (high color-reproduction evaluation parameter HR) is determined by using these color difference .Ei and detection-limit color difference .Ek, and the display property (here, the color reproduction property) of the display device 1 is evaluated by using the high color-reproduction evaluation parameter HR. In other words, the display property is evaluated with use of, as an index, the high color-reproduction evaluation parameter HR obtained by use of the detection-limit color difference .Ek in consideration of the spectral luminous efficiency which has a dependence on color. Therefore, as compared to the techniques in the past in which an evaluation is performed without considering such spectral luminous efficiency which has a dependence on color, an objective display-property evaluation further matching the sense of a human is realized.

As described above, in the present embodiment, the color difference .Ei serving as the measured value is obtained for the display device 1 to be evaluated; the detection-limit color difference .Ek in consideration of the spectral luminous efficiency which has a dependence on color is determined by using the subjective evaluation result of the color difference for the display device 1; the high color-reproduction evaluation parameter HR is determined by using these color difference .Ei and detection-limit color difference .Ek; and the display property (here, the color reproduction property) of the display device 1 is evaluated with use of this high color-reproduction evaluation parameter HR. Therefore, it may be possible to realize an objective display-property evaluation further matching the sense of a human, as compared to the techniques in the past. Accordingly, the display property in the display device 1 can be appropriately evaluated.

Further, for example, by making comparison among the precise color reproduction properties of the respective TV devices with use of the high color-reproduction evaluation parameter HR thus obtained, it may be possible to find, at a design stage, which color has reproducibility desired to be improved, and therefore it may be possible to give feedback to the design of color creation. Besides, also for a user of the display device, there is such an advantage that it may be possible to know, for example, which TV device has an excellent color reproduction property, based on the magnitude of this high color-reproduction evaluation parameter HR. In other words, it may be possible to standardize the criteria of the color reproduction property and the like and thus, each of designers and consumers can compare and study the display properties of display devices by using a common yardstick (index).

Moreover, since the objective display-property evaluation further matching the sense of a human is realized, it may be possible to improve the efficiency of development and design by using this evaluation as a quality evaluation at the development and design stages.

### 2. Modification

Subsequently, modifications (modifications 1 and 2) of the above-described embodiment will be described. Incidentally, the same elements as those in the above-described embodiment will be given the same reference characters as those in the embodiment, and description will be omitted as appropriate.

(Modification 1)

An evaluation method of a display device according to the modification 1 is a method of evaluating a viewing angle property (spectral luminous efficiency angle property) of the display device with use of the high color-reproduction evaluation parameter HR of the above-described embodiment. In other words, in the embodiment, the color reproduction property serving as an example of the display property of the display device is evaluated with use of this high color-reproduction evaluation parameter HR, but in the present modification, the viewing angle property serving as another example of the display property of the display device is evaluated with use of this high color-reproduction evaluation parameter HR.

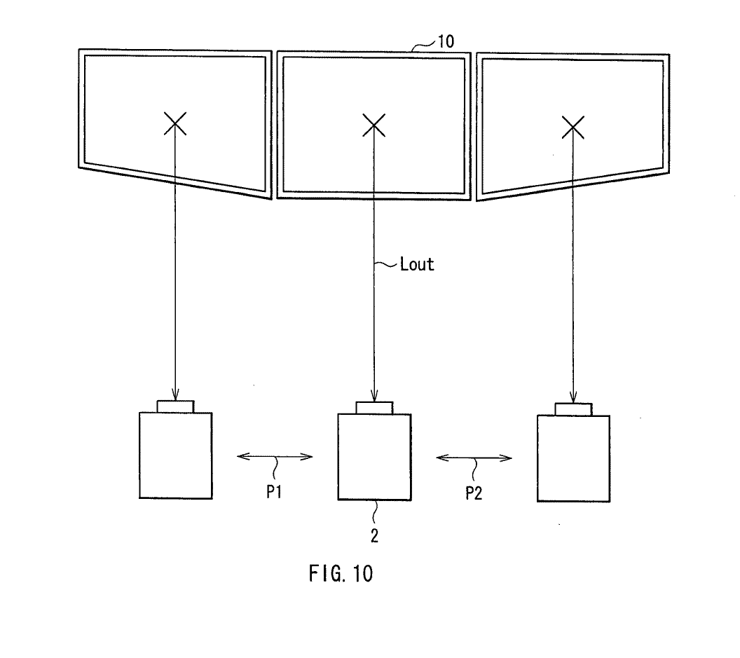

In the present modification, specifically, at first, as indicated by, for example, arrows P1 and P2 in FIG. 10, while a measurement angle (corresponding to the spectral luminous efficiency angle) between the display device 1 to be evaluated and the spectral radiance meter 2 is changed, the color difference .Ei serving as the measured value is obtained from the display light Lout in a manner similar to the above-described embodiment. Also, at the time when the detection-limit color difference ΔEk is obtained, by changing the spectral luminous efficiency angle between the display device 1 and the experimenter in the subjective evaluation experiment, the detection-limit color difference ΔEk is determined based on the result of this subjective evaluation experiment, in a manner similar to the above-described embodiment. Incidentally, the technique of determining the high color-reproduction evaluation parameter HR by using the color difference .Ei and the detection-limit color difference ΔEk thus obtained is the same as that of the above-described embodiment.

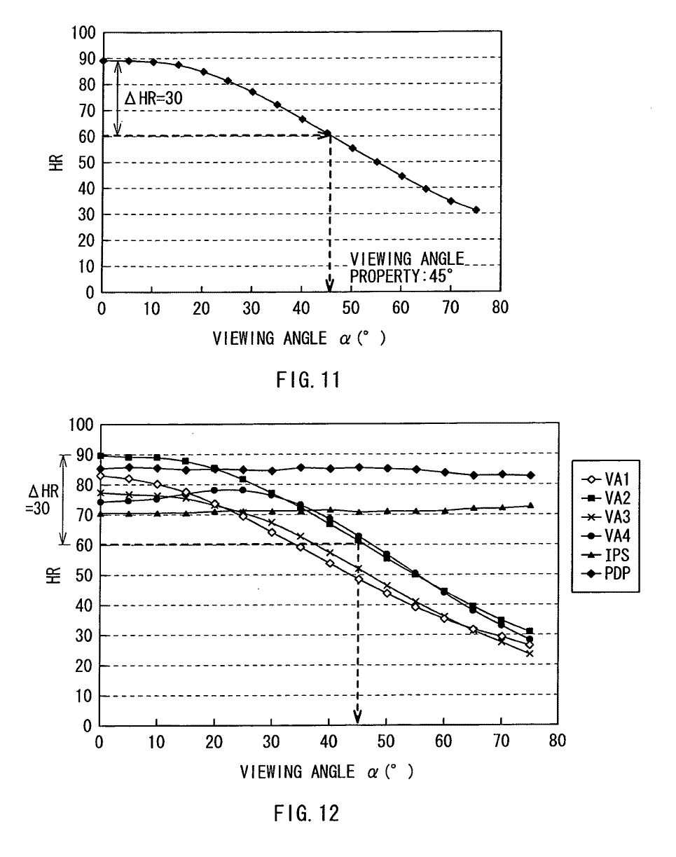

Subsequently, in the present modification, as illustrated in, for example, FIG. 11, the viewing angle property of this display device 1 is evaluated based on, as an index, a change amount ΔHR of the high color-reproduction evaluation parameter HR, which corresponds to a change in the measured angle and the spectral luminous efficiency angle (corresponding to an viewing angle α in FIG. 11) relative to the display device 1. Specifically, here, as illustrated in FIG. 11, with reference to the viewing angle α=0° (frontward direction), the value of the viewing angle α at the time when the change amount ΔHR of the high color-reproduction evaluation parameter HR is 30 is regarded as a viewing-angle-property value (in the example of FIG. 11, the viewing-angle-property value is 45°). Incidentally, the value of the change amount ΔHR of the high color-reproduction evaluation parameter HR at the time when this viewing-angle-property value is determined is not limited to the case of ΔHR=30, but may be determined by using other value.

In this way, in the present modification, the viewing angle property of the display device 1 as illustrated in, for example, FIG. 12 through FIG. 14 is obtained.

Specifically, FIG. 12 illustrates an example of the relationship between the viewing angle α and the high color-reproduction evaluation parameter HR per display system in the display device 1. To be more specific, each of “VA1” through “VA4” represents the property in a liquid crystal display on a Vertical Alignment (VA) system, “IPS” represents the property in a liquid crystal display on an In-Plane Switching (IPS) system, and “PDP” represents the property in a PDP display device. It is apparent from this FIG. 12 that the viewing-angle-property value is 45° in the liquid crystal display on the VA system. Further, the viewing-angle-property value is 75° or more in the liquid crystal display on the IPS system and the PDP display device.

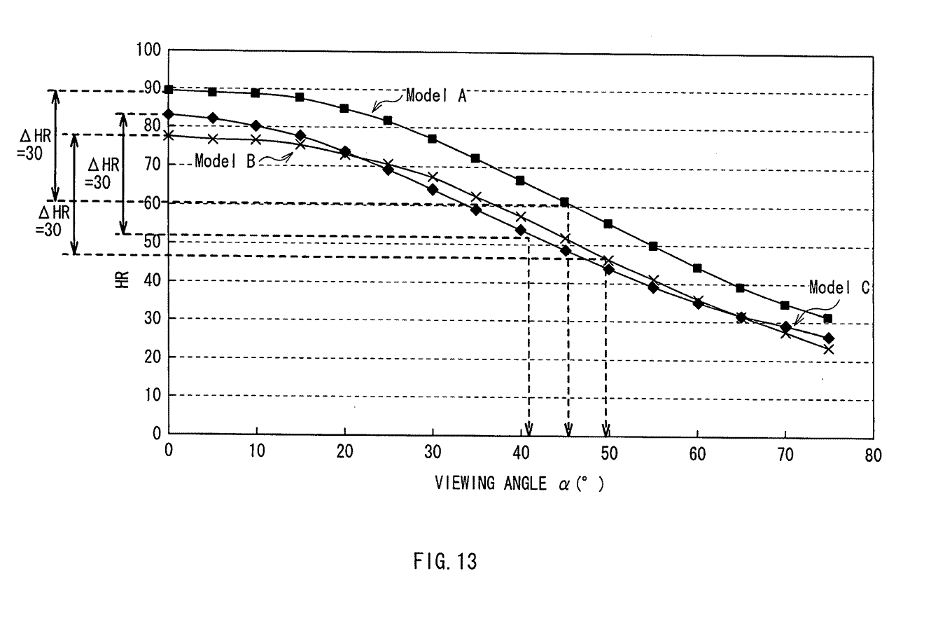

Furthermore, FIG. 13 illustrates an example of the relationship between the viewing angle α and the high color-reproduction evaluation parameter HR per model (models A through C), between the liquid crystal displays on the VA system. It is apparent from this FIG. 13 that the liquid crystal display of the model B has the worst color reproduction property in the frontward direction (viewing angle α=0°) between the three models A through C, while having the best viewing angle property (showing the highest viewing-angle-property value).

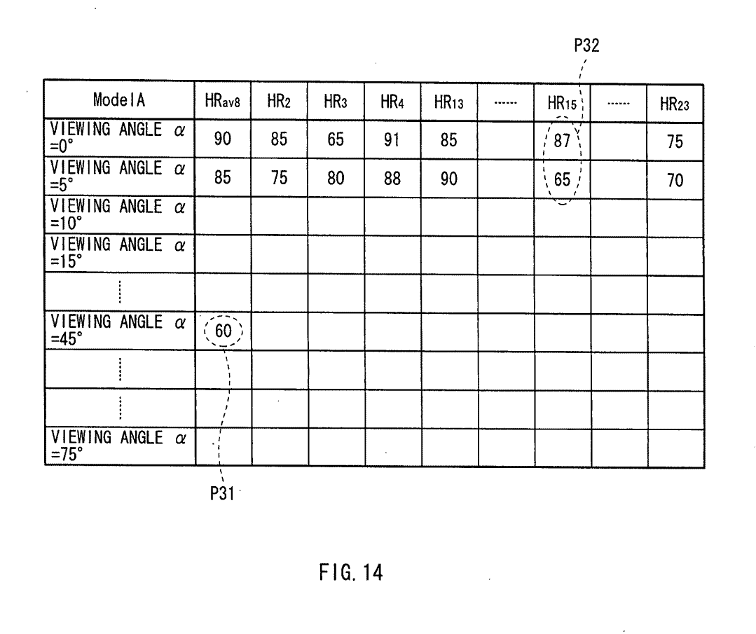

Still furthermore, FIG. 14 illustrates an example of the relationship between the high color-reproduction evaluation parameter HR and the viewing angle α per color, for the liquid crystal display of one model (the above-mentioned model A). Incidentally, “HR2” or the like in FIG. 14 represents the high color-reproduction evaluation parameter HR in, for example, the reference color #2, and “HRav8” represents the above-described average value of the high color-reproduction evaluation parameters HR of the eight reference colors. Further, a sign P31 indicated in FIG. 14 represents the value of the high color-reproduction evaluation parameter HRav8 that defines the viewing-angle-property value. It is apparent from this FIG. 14 that the viewing angle properties vary among the colors, and in, for example, “HR15 (the high color-reproduction evaluation parameter HR of the color #15)” indicated by a sign P32 in FIG. 14, a change in the high color-reproduction evaluation parameter HR when the viewing angle α is altered from 0° to 5° is particularly large. From this fact, it is apparent that in this liquid crystal display, the viewing angle property in the color #15 is particularly poor.

As described above, in the present modification, the viewing angle property of the display device 1 is evaluated with use of the high color-reproduction evaluation parameter HR and thus, it may be possible to realize an objective viewing-angle-property evaluation further matching the sense of a human, as compared to the techniques in the past. Therefore, the viewing angle property in the display device 1 can be appropriately evaluated.

Specifically, the viewing angle property in the past is defined as an angle by which it may be possible to ensure that the value of a contrast ratio is 10:1, according to, for example, a standard of Japan Electronics and Information Technology Industries Association (JEITA). However, this is a value satisfied by almost all the display devices in the world and thus is not practical. Further, previously, the quality of the viewing angle property has not been quantified. In contrast, use of the evaluation parameter according to the present modification makes it possible to perform the quantification of the viewing angle property according to practical use.

(Modification 2)

An evaluation method of a display device according to the modification 2 is a method of evaluating a luminous environment property of the display device with use of the high color-reproduction evaluation parameter HR of the above-described embodiment. In other words, in the embodiment, the color reproduction property serving as an example of the display property of the display device is evaluated with use of this high color-reproduction evaluation parameter HR, but in the present modification, the luminous environment property serving as another example of the display property of the display device is evaluated with use of this high color-reproduction evaluation parameter HR.

In the present modification, specifically, at first, while illuminance of an external environment of the display device 1 to be evaluated is changed, the color difference .Ei serving as the measured value is obtained from the display light Lout in a manner similar to the above-described embodiment. Also, at the time when the detection-limit color difference ΔEk is obtained, by changing the illuminance of the external environment of the display device 1 in the subjective evaluation experiment, the detection-limit color difference ΔEk is determined based on the result of this subjective evaluation experiment, in a manner similar to the above-described embodiment. Incidentally, the technique of determining the high color-reproduction evaluation parameter HR by using the color difference .Ei and the detection-limit color difference ΔEk thus obtained is the same as that of the above-described embodiment.

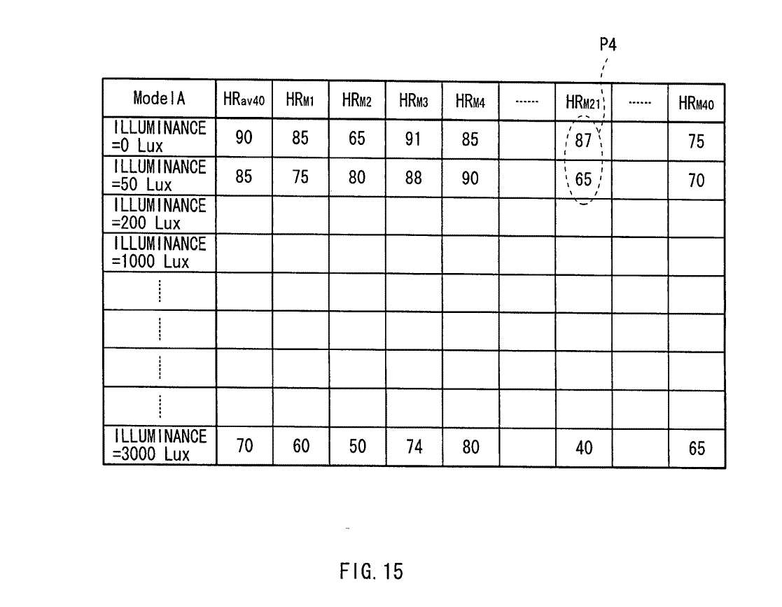

As a result, there is obtained the luminous environment property (the relationship between illuminance per color and the high color-reproduction evaluation parameter HR) of the display device 1 as illustrated in, for example, FIG. 15. Incidentally, “HRM1” or the like indicated in FIG. 15 represents, for example, the high color-reproduction evaluation parameter HR in the reference color (dark skin) of the number 1 (#1) in the Macbeth chart, and “HRav40” represents the average value of these high color-reproduction evaluation parameters HR of 40 colors. It is apparent from this FIG. 15 that the value of the high color-reproduction evaluation parameter HR also alters (decreases) according to a change in the illuminance, and the luminous environment properties vary among the colors. Further, it is found that, for example, in “HRM21” (the high color-reproduction evaluation parameter HR in a light medium gray) indicated by a sign P4 in FIG. 15, a change in the high color-reproduction evaluation parameter HR at the time when the illuminance is altered from 0 Lux to 50 Lux is particularly large. It is apparent from this fact that in this display device 1, the luminous environment property in the light medium gray is particularly poor.

As described above, in the present modification, the luminous environment property of the display device 1 is evaluated with use of the high color-reproduction evaluation parameter HR and thus, it may be possible to realize an objective luminous-environment-property evaluation further matching the sense of a human, as compared to the techniques in the past. Therefore, the luminous environment property in the display device 1 can be appropriately evaluated.

### 3. Application Example

Subsequently, an application example of the evaluation method of the display device described above in the embodiment and modifications will be described.

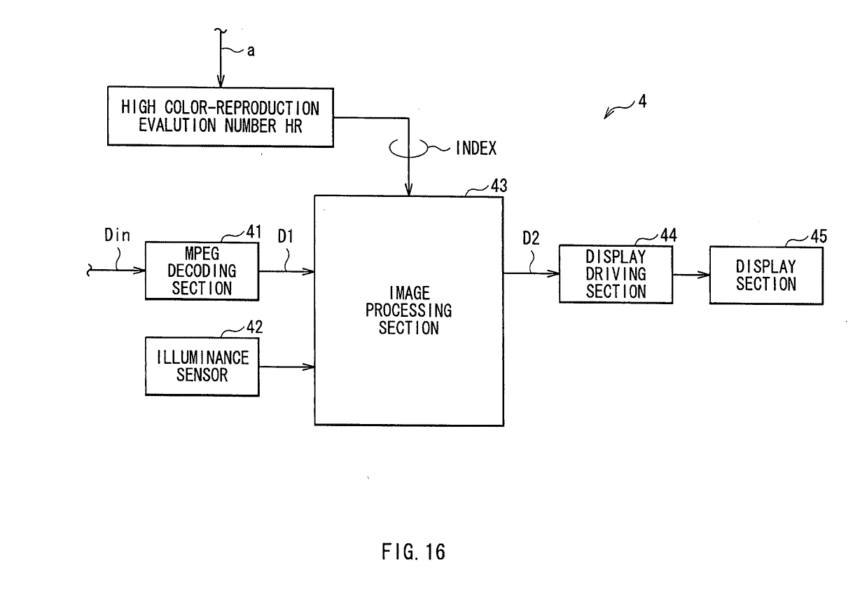

FIG. 16 illustrates a block configuration of a display device (display device 4) that employs the evaluation method of the display device according to the embodiment and the like. The display device 4 is a device that uses the high color-reproduction evaluation parameter HR described above in the embodiment and the like, as an index to be used in design of an image processing section 43. This display device 4 includes, for example, a Moving Picture Expert Group (MPEG) decoding section 41, an illuminance sensor 42, the image processing section 43, a display driving section 44 and a display section 45.

The MPEG decoding section 41 performs MPEG decoding processing on an image signal Din formed by MPEG signal, thereby generating an image signal D1 after decoding.

The illuminance sensor 42 is a sensor measuring illuminance of an external environment of the display device 4.

The image processing section 43 performs, for example, various kinds of image signal processing as illustrated in the figure, by using the image signal D1 and an illuminance detection value output from the illuminance sensor 42, thereby generating an image signal D2 after the image signal processing. This image processing section 43 is obtained with use of the high color-reproduction evaluation parameter HR as an index at the time of its design, as mentioned above.

The display driving section 44 performs display driving of the display section 45 based on the image signal D2. The display section 45 displays an image based on the image signal Din, according to such display driving, and can employ any of display devices in various types of system, such as the CRT, LCD, PDP, and organic EL display.

In this display device 4, with use of the high color-reproduction evaluation parameter HR as the index at the time of the design, it may be possible to obtain a more accurate (correct) color reproduction property than those in the past. Further, as the color reproduction property, in addition to such a correct color reproduction property, a desirable (for a user) color reproduction property may be named, and the evaluation method of the present invention can be applied to a technique of reproducing such a desirable color.

(Other Modification)

Up to this point, the present invention has been described by using the embodiment, modifications and application example, but the present invention is not limited to the embodiment and the like and can be variously modified.

For example, in the embodiment and the like, at the time when the detection-limit color difference ΔEk is determined, the detection-limit color difference ΔEk is defined as the color difference ΔE when the percentage in which the color reference image 32 and the color comparison image 33 appear in the same color (the accumulated number of appearances) is 50%, but the present invention is not limited to this case. In other words, the color difference ΔE when the percentage in which the images appear in the same color is a value other than 50% may be defined as the detection-limit color difference ΔEk.

Further, in the embodiment and the like, there has been described the case in which at the time when the high color-reproduction evaluation parameter HR is determined, the color reproduction coefficient (correction coefficient) a is used as expressed by the above-described equation (6), but this color reproduction coefficient a may not be used in some cases. In other words, the high color-reproduction evaluation parameter HR may be determined through subtracting, from the maximum value (score of 100) of the high color-reproduction evaluation parameter HR, the color difference ratio that is the ratio between the color difference .Ei and the detection-limit color difference .Ek (color difference .Ei/detection-limit color difference .Ek).

Furthermore, the series of processes described for the embodiment and the like may be performed in hardware (circuit), or may be performed in software (program).

The present application contains subject matter related to that disclosed in Japanese Priority Patent Application JP 2009-291251 filed in the Japan Patent Office on Dec. 22, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An evaluation method of a display device, the evaluation method comprising steps of:
obtaining a measured value of color difference, for the display device to be evaluated which is in a state of displaying a predetermined color reference image;
determining a detection limit value of color difference for the display device, in consideration of spectral luminous efficiency which has a dependence on color, with use of a subjective evaluation result of color difference obtained for the display device which is in a state of displaying both the color reference image and a color comparison image in parallel;
determining an evaluation parameter with use of the measured value of color difference and the detection limit value of color difference; and
evaluating a display property of the display device with use of the evaluation parameter.

2. The evaluation method of the display device according to claim 1, wherein the evaluation parameter is determined through subtracting a color difference ratio from a predefined maximum value of the evaluation parameter, the color difference ratio representing a ratio of the measured value of color difference to the detection limit value of color difference.

3. The evaluation method of the display device according to claim 1, wherein the evaluation parameter is determined through subtracting a multiplication resultant value from a predefined maximum value of the evaluation parameter, the multiplication resultant value representing a value obtained through multiplying a color difference ratio by a predetermined correction coefficient, the color difference ratio representing a ratio of the measured value of color difference to the detection limit value of color difference.

4. The evaluation method of the display device according to claim 1, wherein a color reproduction property of the display device is evaluated based on a magnitude of the evaluation parameter.

5. The evaluation method of the display device according to claim 1, wherein a viewing angle property of the display device is evaluated based on an amount of change in the evaluation parameter, the amount of change depending on a change in a measurement angle or a viewing angle, i.e., an angle of direction in which measurement or viewing is performed on the display device.

6. The evaluation method of the display device according to claim 1, wherein a value of color difference defined in CIELAB color space is used.
